(19) United States
(12) Patent Application Publication
(10) Pub. No.: US 2026/0156733 A1
(43) Pub. Date: Jun. 4, 2026

(54) METHOD AND SERVER FOR UPGRADING INTELLIGENT LIGHTING SYSTEM, AND NETWORK DEVICE ASSOCIATED WITH INTELLIGENT LIGHTING SYSTEM

(71) Applicant: LEDVANCE GmbH, Garching bei München (DE)

(72) Inventors: Yafen ZHANG, Shenzhen Guangdong (CN); Florian KRONAST, Raubling (DE); Eden LIU, Shenzhen Guangdong (CN); Jiayi YAN, Shenzhen Guangdong (CN)

(21) Appl. No.: 19/405,518

(22) Filed: Dec. 2, 2025

(30) Foreign Application Priority Data
Dec. 3, 2024 (CN) 202411764064.9

(51) Int. Cl. H05B 47/19; G06F 8/65; H04L 41/082

(52) U.S. Cl. CPC H05B 47/19; G06F 8/65; H04L 41/082

(57) ABSTRACT

A method for upgrading an intelligent lighting system including a plurality of network devices configured to communicate wirelessly in accordance with at least one internal communication protocol and at least one external communication protocol is provided. The method includes: transmitting an over-the-air (OTA) file to at least one first proxy device among the plurality of network devices; updating said device by updating firmware thereof based on the OTA file; automatically configuring said device as an OTA server; transmitting the OTA file from said device to at least one second proxy device among the plurality of network devices; and updating the at least one second proxy device by updating firmware thereof based, at least in part, on the OTA file received from the at least one first proxy device. Additionally, a network device and a server are provided.

### CROSS-REFERENCE TO RELATED APPLICATIONS

This patent application claims the benefit of and priority to Chinese Patent Application No. 202411764064.9, filed on Dec. 3, 2024, which is herein incorporated by reference in its entirety.

### FIELD OF THE DISCLOSURE

The present disclosure generally pertains to intelligent networks. More particularly, the present disclosure is directed to method and server for upgrading intelligent lighting systems, and further to network devices associated with such intelligent lighting systems.

### BACKGROUND

It is known that lighting systems may incorporate intelligent programmable devices. Such programmable devices can include controllers configured with software or firmware to provide selected functionality. From time to time, particularly upon the release of new software or hardware, updating these systems becomes necessary. However, the updating process can be time-consuming and burdensome.

### SUMMARY

An objective of the present disclosure is to provide a particularly easy and rapid method for performing upgrades of an intelligent lighting system.

According to a first aspect of the present disclosure, a method for upgrading an intelligent lighting system including a plurality of network devices or networkable devices is provided. The network devices are configured to implement wireless communication in accordance with at least one internal communication protocol and at least one external communication protocol.

In a non-limiting embodiment, the network devices or at least some network devices may be configured to communicate internally (i.e., within the network) with each other based on at least one internal communication protocol (e.g., ZigBee, Bluetooth, or other mesh communication protocols). ZigBee is a registered trademark of the ZigBee Alliance. Bluetooth is a registered trademark of Bluetooth Special Interest Group (SIG).

The network devices or at least some of the network devices may be further configured to communicate with an external device, such as a server, in accordance with at least one external communication protocol (e.g., Bluetooth Low Energy (BLE) or Wi-Fi). Bluetooth is a registered trademark of Bluetooth SIG. Wi-Fi is a registered trademark of the Wi-Fi Alliance.

The method includes transmitting an over-the-air (OTA) file to at least one first proxy device among the plurality of network devices. The OTA file may contain software or firmware for OTA upgrades of the network devices.

The at least one first proxy device may include one or more proxy devices configured as OTA clients to receive the OTA file from an external server via an external communication path, or from another network device configured as an OTA server via an internal communication path. Here, the external server may be a mobile device running a mobile application or a computer running a PC-based application. When receiving the entire file, the proxy device checks the OTA file and determines whether to perform an update. Subsequently, the proxy device automatically configures itself as an OTA server. As an OTA server, the proxy device may notify other devices that new firmware is available for upgrade. The internal communication path may be established in accordance with at least one internal communication protocol, and the external communication path may be established in accordance with at least one external communication protocol. In some embodiments, the at least one internal communication protocol and the at least one external communication protocol may include one or more common communication protocols.

The method further includes: updating the at least one first proxy device by updating its firmware based on the OTA file, and automatically configuring the proxy device (i.e., the at least one proxy device) as an OTA server. The method further includes: transmitting the OTA file from the at least one first proxy device to at least one second proxy device among the plurality of network devices, and updating the at least one second proxy device by updating its firmware based, at least in part, on the OTA file received from the at least one first proxy device.

Thus, once the OTA file is transmitted to at least one first network device among the plurality of network devices, the lighting system update can be executed by the network devices with substantially no external assistance through repeatedly performing the aforementioned steps until ultimately all network devices are updated.

Furthermore, the lighting system update may be executed like an avalanche, where the second proxy transmits the OTA file to a third proxy, the third proxy transmits the OTA file to a fourth proxy, and so forth. Consequently, the transmission of the OTA file can be accelerated, and the overall update time of the system can be significantly reduced.

Transmitting the OTA file to the proxy device, specifically transmitting the OTA file from a server or from another network device acting as an OTA server to the proxy device, may include: sending an OTA notification message containing version information of the OTA file, and during OTA version checking, the proxy device verifies the version and indicates readiness to receive the OTA file.

In a non-limiting embodiment, the version information may be provided in an image identification (ID) within the file header of the OTA file. The image ID may serve as a unique identifier for distinguishing specific firmware or software versions and ensures that the correct software is used for updating the corresponding device.

Verifying the OTA version may include: checking whether the OTA file version is newer than the current version implemented in the proxy device. Once the version is verified to be newer than the current version, the proxy device may indicate readiness for receiving the OTA file, to the server or another network device acting as the server.

Configuring at least one first proxy device may include: disabling the OTA client function and enabling the OTA server function of the at least one proxy device. In some embodiments, the disabling and enabling are accomplished during the process of rebooting the at least one proxy device. Thus, the proxy device can switch from an OTA client mode to an OTA server mode. By disabling the OTA client function, any OTA file transmitted to the proxy device (e.g., from the server's application or any other network device) can be prevented.

Before transmitting the OTA file to at least one second proxy device, the at least one first proxy device may identify whether the network is busy, and delay the transmission of the OTA file by a predefined duration if network is identified to be busy. In this way, the at least one first proxy device can initiate the transmission of the OTA file when the network or other network devices are not busy and are ready for receiving the OTA file.

In some embodiments, before transmitting the OTA file to at least one second proxy device, the at least one first proxy device sends an OTA notification message to other network devices. In a non-limiting embodiment, after a predefined delay period, the at least one first proxy device may operate as an OTA server and notifies other devices to update the devices.

In a non-limiting embodiment, the at least one proxy device may be configured to transmit the OTA file to the first number N (e.g., three) of proxy devices that respond to the OTA notification accordingly. By transmitting the OTA file, the second proxy device functions as an OTA server, which can send notifications and transmit OTA files to the first number N of three proxy devices. Thus, by repeating the above steps, each network device requiring an update can ultimately be updated, either directly from the external server or from another network device, with one, two, or multiple transmission hops.

The method may include initiating the update process via an external server or a server device that carries the OTA file for OTA upgrades of the lighting system. The external server or server device may be, for example, a portable device such as a smartphone, or a personal computer installed with a specific program configured to carry and distribute the OTA file. In a non-limiting embodiment, the server device may be configured with appropriate software or an application capable of reading and retrieving the OTA file from the server's memory unit. The external server may establish wireless communication with an initial proxy device among the plurality of network devices in accordance with at least one external communication protocol (e.g., BLE or Wi-Fi), and transmit the OTA file to the initial proxy device. The initiating may include reading and retrieving the OTA file from the memory unit of the external server, obtaining an image ID from the OTA file, and scanning and discovering network devices supporting at least one communication protocol for the same image ID.

The initial proxy device may be selected based, at least in part, on received signal strength indicator (RSSI). In a non-limiting embodiment, the initial proxy device may be the nearest network device exhibiting the strongest RSSI. Thereby, reliable communication is allowed to be established between the external server and the network device.

The initial proxy device may also be selected based, at least in part, on the date of its last firmware update. For example, if no Bluetooth network device has an image ID matching that of the OTA file, the Bluetooth network device with the most recent firmware update will be selected as the initial proxy device. This increases the likelihood that the initial proxy device is not entirely outdated and can be used to execute the method.

According to a second aspect of the present disclosure, a network device for an intelligent lighting system is provided.

The network device includes a processor and a memory unit for storing firmware, data, and machine-readable instructions executable by the processor.

The network device further includes an interface configured to wirelessly communicate in accordance with at least one internal communication protocol for communicating with other network devices within the lighting system and at least one external communication protocol for communicating with an external server.

The at least one external communication protocol may include, for example, BLE or Wi-Fi protocol. The at least one internal communication protocol may include, for example, ZigBee or Bluetooth protocol, for wirelessly connecting network devices to form a smart network.

The machine-readable instructions include instructions executable by the processor which, when executed by the processor, cause the processor to receive an OTA file from an OTA server and update the firmware based on the OTA file received from the OTA server. The OTA server may be an external device configured to operate as an OTA server and/or another network device among the plurality of network devices temporarily configured as an OTA server.

The machine-readable instructions may further include instructions to configure the network device as an OTA server and transmit/distribute the OTA file to other network devices for updating the firmware of the other network devices.

According to a third aspect of the present disclosure, a server for upgrading an intelligent lighting system including a plurality of network devices is provided. In a non-limiting embodiment, the network device may be configured according to the network device of the second aspect described above. The server includes: a processor and a memory unit for storing data and machine-readable instructions executable by the processor.

The server further includes an interface configured to wirelessly communicate with the network device based on at least one external communication protocol, such as BLE or Wi-Fi.

The memory unit contains an OTA file for upgrading the network device, and the machine-readable instructions include instructions executable by the processor which, when executed by the processor, cause the server to establish wireless communication with an initial proxy device of the lighting system, read and retrieve the OTA file, and transmit the OTA file to the initial proxy device via the wireless communication.

The machine-readable instructions may include instructions executable by the processor which, when executed by the processor, cause the processor to read and retrieve the OTA file header and transmit the OTA file header to the initial proxy device. Thus, the initial proxy device may check whether the OTA file header matches the initial proxy device. In this case, the initial proxy device may initiate the OTA itself and then reboot to switch from an OTA client to an OTA server. In the event that the OTA file does not match the initial proxy device, the initial proxy device may switch to function as an OTA server to transmit the OTA file to other network devices. Thus, the server can initiate a system upgrade even if the initial proxy device does not require an upgrade or the OTA file does not match the initial proxy device.

In the following description, details are provided to describe embodiments of the present description. However, it will be apparent to those skilled in the art that the embodiments may be practiced or implemented without these details.

Some components of the embodiments have similar components. Similar components may have identical names or similar component numbers. Where appropriate, the description of one component applies by reference to another similar component, thereby reducing textual repetition without limiting the disclosure.

### BRIEF DESCRIPTION OF THE DRAWINGS

FIG. 1 schematically illustrates a method for upgrading an intelligent lighting system according to an embodiment.

FIG. 2 shows a flowchart of a method for controlling lights of a lighting system according to an embodiment.

### DETAILED DESCRIPTION

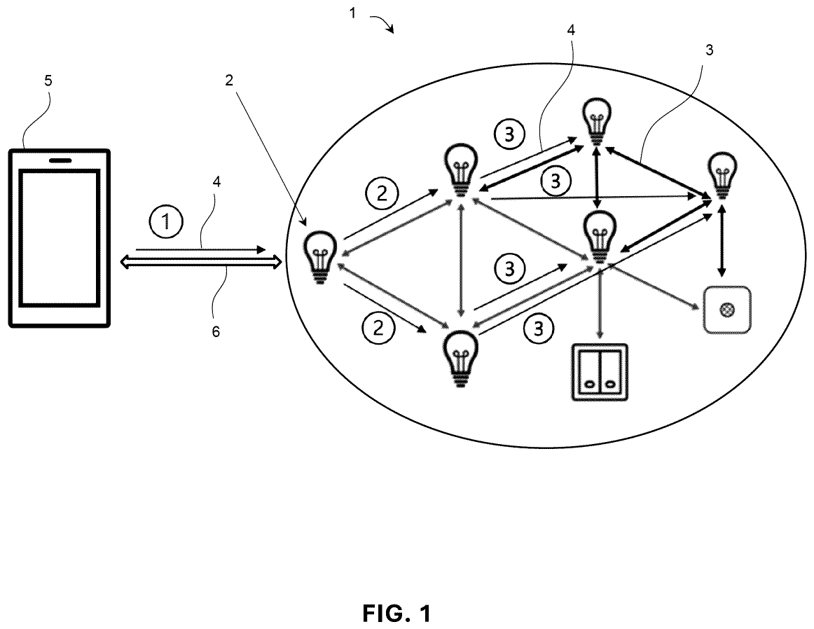

FIG. 1 schematically illustrates a method for upgrading an intelligent lighting system 1 according to an embodiment.

In a non-limiting embodiment, FIG. 1 shows an intelligent lighting system 1 having a plurality of network devices 2. The intelligent lighting system 1 may include, without limitation, any number of controllable lights, switches, and/or sensors as schematically represented by corresponding pictograms in FIG. 1.

The network devices 2 are configured to communicate with each other via wireless communication paths 3 based on at least one internal wireless communication protocol. As depicted in FIG. 1, the solid double-headed arrows represent wireless communication paths 3 between the network devices 2 within the intelligent lighting system 1, via which communication is performed based on the internal communication protocol.

At least some of the network devices 2 may be configured as intelligent network devices supporting the upgrade process according to a method of the present disclosure. In a non-limiting embodiment, such network devices 2 may each include a processor, a memory unit for storing firmware, data, and machine-readable instructions executable by the processor, and an interface. For purposes of conciseness, the processors, memory units, and interfaces of the network devices 2 are not shown.

The interface may be configured for wireless communication in accordance with at least one internal communication protocol (e.g., ZigBee). As used herein, internal communication refers to communication between the network devices 2 within the intelligent lighting system 1.

The interface may be further configured for wireless communication with external devices or devices not belonging to intelligent lighting system 1, in accordance with at least one external communication protocol. In a non-limiting embodiment, the network devices 2 each may be configured to implement multiple communication protocols concurrently within the network devices 2, such as Bluetooth and ZigBee.

The machine-readable instructions may include instructions executable by the processor which, when executed by the processor, causes the processor to receive an OTA file from an OTA server and update the firmware based on the OTA file received from the OTA server. The machine-readable instructions may include instructions executable by the processor which, when executed by the processor, causes the processor to configure one of the network devices 2 as an OTA server and transmit the OTA file to other network devices for upgrading the firmware of the other network devices. In a non-limiting embodiment, the OTA file may be transmitted from one network device 2 to another via wireless transmission 4 (as schematically indicated by the unidirectional arrow in FIG. 1).

FIG. 1 further shows a server 5 configured to initiate a system upgrade. In the embodiment shown, the server 5 is configured as a portable smart device containing an OTA file for OTA upgrades of the intelligent lighting system 1.

In a non-limiting embodiment, the server 5 may include a processor, a memory unit for storing firmware, data, and machine-readable instructions executable by the processor, and an interface configured for wireless communication with the network devices 2. For purposes of conciseness, the processor, memory unit, and interface of the server 5 are not shown.

The memory unit of the server 5 contains an OTA file for upgrading network device 2, and the machine-readable instructions include instructions executable by the processor which, when executed by the processor, causes the processor to establish wireless communication with an initial proxy device of the intelligent lighting system 1, read the OTA file, and transmit the OTA file to the initial proxy device.

The hollow double-headed arrow schematically represents the wireless communication path 6 between the server 5 and the initial proxy device.

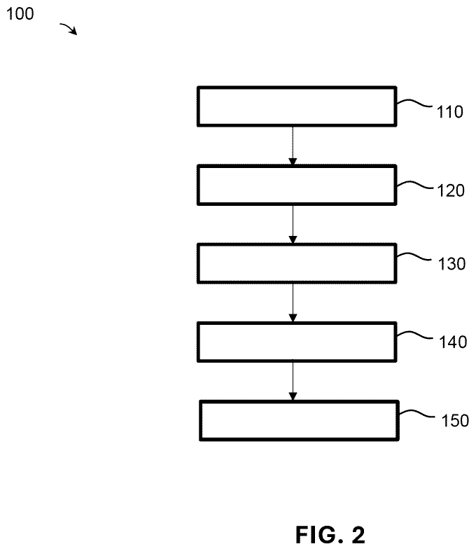

FIG. 2 shows a flowchart of a method 100 for controlling lights of a lighting system 1 according to an embodiment.

The method 100 includes, at step 110, transmitting an OTA file to at least one first proxy device among a plurality of network devices 2.

The transmission of the OTA file at step 110 may be performed by an external server 5 via the wireless communication path 6, as schematically depicted in FIG. 1. In this case, the at least one first proxy device will act as the initial proxy device, which first receives the OTA file from the server 5.

Alternatively, or additionally, the transmission of the OTA file at step 110 may be performed by any network device 2 that has already received the OTA file (specifically, as an OTA client) and switches from the OTA client mode to the OTA server mode.

Thus, the at least one first proxy device does not necessarily include the initial proxy device that first obtained the OTA file from the server 5 during the upgrade initiation process.

The method 100 further includes, at step 120, updating the at least one first proxy device. In a non-limiting embodiment, after the upgrade process is initiated by the server 5, and once the at least one first proxy device has received the OTA file, the at least one first proxy device may, at step 120, upgrade its firmware based on the received OTA file.

The method 100 further includes, at step 130, configuring the at least one first proxy device as an OTA server. In a non-limiting embodiment, the configuration at step 130 may include disabling the OTA client function and enabling the OTA server function of the at least one first proxy device. The configuration of the at least one first proxy device may include rebooting the at least one first proxy device such that, after rebooting, the at least one first proxy device operates as an OTA server instead of as an OTA client. By disabling the OTA client function, any interference with the upgrade process caused by, for example, OTA file transmission from the server's 5 application or any other network device 2 to the at least one first proxy device can be prevented. After the at least one first proxy device completes the transmission of the OTA file, the OTA client function is re-enabled to prepare for the subsequent new firmware upgrade.

The method 100 further includes, at step 140, transmitting the OTA file from the at least one first proxy device to at least one second proxy device among the plurality of network devices 2. The method 100 further includes, at step 150, updating the at least one second proxy device by upgrading its firmware based, at least in part, on the OTA file received from the at least one first proxy device.

Returning to FIG. 1, the foregoing steps of the method 100 may be visualized with the aid of the arrows shown in FIG. 1. In a non-limiting embodiment, the server 5 may establish a wireless communication path 6 with the initial proxy device and perform wireless transmission 4 of the OTA file to the initial proxy device.

The selection of the initial or first proxy device may be based, at least in part, on the strength or RSSI associated with the wireless communication path to ensure reliable transmission of the OTA file to the intelligent lighting system 1.

Some devices within the internal network, such as legacy sensors, may support only internal protocols and may not support external communication protocols. Such legacy devices cannot serve as proxy devices to directly receive OTA files from external servers (e.g., via Bluetooth from a mobile application). Users may connect to other types of devices with Bluetooth/Wi-Fi connectivity and designate such a specific device with Bluetooth/Wi-Fi connectivity as a proxy. In this case, the selection of the initial proxy device also may be based, at least in part, on the date of its last firmware update. For example, if the firmware update of a network device 2 is significantly outdated, this may indicate that the network device 2 is unsuitable as a proxy for performing OTA updates, as the network device 2 itself also may be ready to receive updates from other internal devices. In such cases, the server 5 may search for another network device that can be selected as the initial proxy device.

This initial transmission of the OTA file from the server 5 to the intelligent lighting system 1 is represented by the circled numeral “1” in FIG. 1.

Upon receiving the OTA file, the initial proxy device may perform the upgrade and transmit or forward the OTA file to other network devices. This “second update tier transmission” is labeled with the circled numeral “2” in FIG. 1. The transmitting or forwarding the OTA file may be repeated in the “third update tier” (labeled with the circled numeral “3”), or the OTA file may be further transmitted, ultimately updating the entire network. Each network device 2 acting as an OTA server may transmit the OTA file to a plurality of other network devices (e.g., two, three, or more), expanding the update coverage by update tiers, thereby significantly reducing the overall update time for large-scale networks.

In a non-limiting embodiment, in aforesaid steps 110 and/or 140, transmitting the OTA file to the at least one first proxy device may include: sending an OTA notification message containing version information of the OTA file, verifying the version by the receiving proxy device or OTA client, and indicating readiness to receive the OTA file to the OTA server. In a non-limiting embodiment, when checking the OTA version, the OTA client may respond to the OTA server and indicate readiness for the OTA file. The OTA server may be implemented as an external server 5 or a network device 2 configured to operate an OTA server.

In a non-limiting embodiment, upon receiving the OTA notification message or OTA file header, if the OTA file is checked to be intended for the proxy device or OTA client, the proxy device or OTA client may check the OTA file header and initiate its firmware update. Subsequently, the proxy device may restart automatically and operate in the OTA server mode.

If the verification of the OTA file header indicates that the file is not intended for the proxy device or OTA client, the proxy device or OTA client switches from the OTA client mode to the OTA server mode without performing a firmware update.

Switching to the OTA server mode, with or without prior update of its firmware, may include: disabling the OTA client mode such that the OTA proxy device is not subject to interference from any OTA server scanning OTA clients. Switching to the OTA server mode may further include: automatically initiating notifications to other devices regarding an impending firmware update.

Prior to transmitting the OTA file at steps 110 and/or 140, the OTA server and/or the network device 2 operating in the OTA server mode may identify whether the network of intelligent lighting system 1 or other network devices are currently busy, and if the network is identified to be busy, the transmission of the OTA file may be delayed by a predefined duration, such as 2 minutes. Such a delay avoids unnecessary data traffic.

The aforementioned method 100 provides an efficient and rapid approach for upgrading systems, particularly gateway-free systems, as such systems cannot be updated remotely and on-site updates using conventional methods can be extremely time-consuming. Essentially, OTA upgrades can be initiated by any updated device to one or more neighboring devices, thereby accelerating the updating of additional devices during the upgrade process and facilitating rapid distribution of the OTA file throughout the intelligent lighting system 1.

Although some embodiments have been described in detail above, it should be understood that numerous variations, modifications, and alternative embodiments may be devised without departing from the scope of the present disclosure. The one or more embodiments are provided merely by way of example and are not intended to limit the scope, applicability, or configuration of the present disclosure in any respect. Rather, the foregoing detailed description is intended to provide those skilled in the art with a convenient roadmap for implementing the disclosed embodiments.

### List of Reference Numerals

1 Intelligent Lighting System
2 Network Device(s)
3 Wireless Communication Path
4 Wireless Transmission
5 Server
6 Wireless Communication Path
7 Device Discovery Module
100 Method for Upgrading an Intelligent Lighting System
110 Transmitting an OTA file to at least one first proxy device
120 Updating the at least one first proxy device
130 Configuring the at least one first proxy device as an OTA server
140 Transmitting the OTA file from the at least one first proxy device to at least one second proxy device
150 Updating the at least one second proxy device

What is claimed is:

1. A method for upgrading an intelligent lighting system comprising a plurality of network devices configured to communicate wirelessly in accordance with at least one internal communication protocol and at least one external communication protocol, the method comprising:
transmitting an over-the-air (OTA) file to at least one first proxy device among the plurality of network devices;
updating the at least one first proxy device by updating firmware of the at least one first proxy device based on the OTA file;
automatically configuring the at least one first proxy device as an OTA server;
transmitting the OTA file from the at least one first proxy device to at least one second proxy device among the plurality of network devices; and
updating the at least one second proxy device by updating firmware of the at least one second proxy device based, at least in part, on the OTA file received from the at least one first proxy device.

2. The method according to claim 1, wherein:
transmitting the OTA file to the proxy device comprises:
sending an OTA notification message containing version information of the OTA file; and
the method further comprises;
verifying the version information by the proxy device; and
indicating readiness to receive the OTA file when the version information is verified.

3. The method according to claim 1, wherein automatically configuring the at least one first proxy device comprises:
disabling an OTA client function of the at least one first proxy device; and
enabling an OTA server function of the at least one first proxy device.

4. The method according to claim 1, wherein prior to transmitting the OTA file to the at least one second proxy device, the at least one first proxy device identifies whether a network comprising the plurality of network devices is busy, and when the network is identified to be busy, delaying transmission of the OTA file to the at least one second proxy device by a predefined time.

5. The method according to claim 1, wherein prior to transmitting the OTA file to the at least one second proxy device, the at least one first proxy device sends an OTA notification message to another of the plurality of network devices in the intelligent lighting system for updating.

6. The method according to claim 1, further comprising:
initiating an update process by an external server carrying the OTA file for OTA upgrade of the intelligent lighting system, wherein the external server establishes wireless communication with an initial proxy device among the plurality of network devices; and
transmitting the OTA file to the initial proxy device in accordance with at least one external communication protocol.

7. The method according to claim 6, wherein the initial proxy device is selected based, at least in part, on a received signal strength indicator (RSSI).

8. The method according to claim 6, wherein the initial proxy device is selected based, at least in part, on a date of a last firmware update of the initial proxy device.

9. A network device associated with an intelligent lighting system, the network device comprising:
a first processor;
a first memory unit for storing firmware, first data, and first machine-readable instructions executable by the first processor; and
a first interface configured to wirelessly communicate in accordance with at least one internal communication protocol and at least one external communication protocol;
wherein the machine-readable instructions comprise instructions executable by the first processor which, when executed by the first processor, cause the network device to:
receive an OTA file from an OTA server;
update the firmware based on the OTA file received from the OTA server;
configure the network device as an OTA server; and
transmit the OTA file to another network device in the intelligent lighting system for firmware update of the another network device.

10. A server for upgrading an intelligent lighting system comprising a plurality of network devices according to claim 9, the server comprising:
a second processor;
a second memory unit for storing second data and second machine-executable commands executable by the second processor; and
a second interface configured to wirelessly communicate with the plurality of network devices;
wherein:
the second memory unit contains the OTA file for upgrading the plurality of network devices; and
the second machine-readable instructions comprise instructions executable by the second processor which, when executed by the second processor, cause the server to establish wireless communication with an initial proxy device of the intelligent lighting system, read and retrieve the OTA file, and transmit the OTA file to the initial proxy device via the wireless communication.
